(19) United States
(12) Patent Application Publication
(10) Pub. No.: US 2026/0347143 A1
(43) Pub. Date: Nov. 5, 2026

(54) METHOD OF DETERMINING A POSITION OF AN ELEVATOR CAR OF AN ELEVATOR SYSTEM

(71) Applicant: Inventio AG, Hergiswil (CH)

(72) Inventor: Antonio Perfetto, Ebikon (CH)

(21) Appl. No.: 18/997,535

(22) PCT Filed: Jul. 17, 2023
(86) PCT No.: PCT/EP2023/069799

§ 371 Date: Jan. 22, 2025

(30) Foreign Application Priority Data
Jul. 29, 2022 (EP) 22187732.7

(51) Int. Cl. B66B 1/34

(52) U.S. Cl. CPC B66B 1/3492

(57) ABSTRACT

A method determines a position of an elevator car of an elevator system, the car being movable in an elevator shaft of the system. The method includes: imaging a shaft component of the system using an imaging sensor mounted to the car, the imaging sensor automatically adjusting a shutter value of the imaging sensor during imaging; moving the car along a travel axis in the shaft; detecting a first marker while moving the car, the first marker being positioned on the shaft component of the system, wherein the first marker is detected based on the shutter value of the imaging sensor; and determining a first position of the elevator car based on the detection of the first marker.

### FIELD

The present invention relates to a method and a system for determining a position of an elevator car of an elevator system, particularly of an elevator system for transporting passengers.

### BACKGROUND

Conventional elevators include systems for determining a position of an elevator car of the elevator. Usually, the position of the elevator car in the direction of travel is required by an elevator controller to be able to move and position the elevator car safely and precisely within the elevator shaft. For example, EP 3 625 160 B1 refers to a relative position determination based on an acquisition of images of shaft equipment. In particular, a current image is compared to a previous image to determine a displacement of the elevator car.

However, conventional techniques of determining a position of an elevator car based on relative position determination may not be very accurate, particularly if the position is to be used for reliable or precise positioning of the elevator car. Known systems may use additional sensor systems or considerable computational resources to precisely determine the position of the elevator car.

### SUMMARY

Accordingly, there is a need for methods and systems for determining a position of an elevator car, which are improved with respect to conventional techniques, particularly with respect to the complexity, the precision, the costs or the reliability of the position determination. Such needs are met with the subject matter of the advantageous embodiments defined in the following specification.

In one aspect, a method of determining a position of an elevator car of an elevator system is provided. The elevator car is movably arranged in an elevator shaft of the elevator system. The method includes imaging a shaft component of the elevator system using an imaging sensor mounted to the elevator car, the imaging sensor automatically adjusting a shutter value of the imaging sensor during imaging. The method further includes moving the elevator car along a travel axis of the elevator car. The method includes detecting a first marker while moving the elevator car, the first marker being positioned on the shaft component of the elevator system, wherein the first marker is detected based on the shutter value of the imaging sensor. The method further includes determining a first position of the elevator car based on the detection of the first marker.

In another aspect, a system for determining a position of an elevator car of an elevator system is provided, the elevator car being movably arranged in an elevator shaft. The system includes an imaging sensor configured to be mounted to the elevator car, the imaging sensor being configured to automatically adjust a shutter value of the imaging sensor during imaging of a shaft component of the elevator system. The system further includes one or more of a first marker. The system includes a controller communicatively coupled to the imaging sensor, the controller being configured to detect the one or more first marker on the shaft component of the elevator system based on the shutter value of the imaging sensor, and wherein the controller is further configured to determine a first position of the elevator car based on the detection of a first marker of the one or more first marker.

In yet another aspect, an elevator system is provided. The elevator system includes an elevator car and a shaft component. The elevator system further includes a system for determining a position of the elevator car of the elevator system according to embodiments described herein, wherein the imaging sensor is mounted to the elevator car, and wherein the one or more first marker is positioned on the shaft component of the elevator system.

According to embodiments of the present disclosure, the elevator system includes an elevator car movably arranged in an elevator shaft of the elevator system. In particular, the elevator car is movable along a travel axis of the elevator car. The travel axis may be vertical axis, particularly oriented vertically along a direction of gravity. The elevator system may include a plurality of landings, at which passengers may enter or exit the elevator car. In embodiments, each landing includes a landing door. Passengers may enter and exit the elevator car through the landing door and through a car door of the elevator car.

In embodiments, the elevator system includes a shaft component. The shaft component may include one or more shaft walls of the elevator system and/or shaft equipment of the elevator system. The shaft equipment may particularly include one or more guide rail arranged in the elevator shaft, one or more landing door and/or one or more door frame for a landing door. In embodiments, the shaft component is stationary in a vertical direction.

According to some embodiments, the position of the elevator car to be determined is a position of the elevator car along the travel axis of the elevator car, particularly a vertical position. In embodiments, the position to be determined may be an absolute position of the elevator system. For example, the absolute position may be a position relative to a reference point of the elevator system, such as the maximum position or minimum position of the elevator car in the elevator system. In some embodiments, the position of the elevator car to be determined may be a relative position, e.g. a relative position with respect to a landing or a landing door.

In embodiments, an imaging sensor may be mounted to the elevator car or may be configured to be mounted to the elevator car. The imaging sensor can be arranged on the elevator car for imaging a shaft component of the elevator system. It should be understood that according to embodiments, the imaging sensor is configured for imaging only a part of the shaft component at any given time, particularly a part of the shaft component corresponding to a field of view of the imaging sensor. In embodiments, the imaging sensor is mounted to an outside of the elevator car to image the shaft component of the elevator system. For example, the imaging sensor may be mounted to face a side of the elevator car, e.g. for imaging a guide rail of the elevator system. In further embodiments, the imaging sensor may be mounted on the same side as a car door of the elevator car, e.g. for imaging landing doors of the elevator system or door frames of the elevator system. In some embodiments, more than one imaging sensor may be mounted to the elevator car, particularly for imaging more than one region of the shaft component of the elevator system.

In some embodiments, the imaging sensor includes a light source configured for illuminating a field of view of the imaging sensor. The light source may include a light emitting diode (LED). The LED may be a Laser-LED. The light source may emit light for example in the visible spectrum and/or in the infrared.

According to embodiments, the imaging sensor is an optical tracking sensor. The imaging sensor may be configured for determining or tracking a position of the elevator car, particularly a relative displacement of the elevator car. The imaging sensor may include a camera. The imaging sensor may be a two-dimensional imaging sensor, particularly for providing two-dimensional images of the shaft component of the elevator system. For example, the imaging sensor may be or may include an optical flow sensor. The imaging sensor may be configured to acquire a series of images over time. In embodiments, the imaging sensor is configured to evaluate at least a current image and a previous image, for example by digital image correlation (DIC) and/or optical flow analysis. The imaging sensor or a controller according to embodiments described herein may be configured to derive motion data indicative of the relative displacement of the elevator car over time. Motion data indicative of a speed and/or an acceleration may be derived from data indicative of the relative displacement of the elevator car.

In embodiments, the imaging sensor acquires images using a shutter value of the imaging sensor. The shutter value corresponds to an exposure time of the imaging sensor, e.g. an exposure time of an imaging chip of the imaging sensor. In particular, the exposure time is indicative of the time of light exposure of the imaging chip for the acquisition of an image. The shutter value may be particularly defined by a reflectance of the surface imaged by the imaging sensor. According to embodiments, the imaging sensor is configured to automatically adjust the shutter value during imaging based on a brightness value. For example, the imaging sensor may adjust the shutter value based on one or more brightness values, e.g. brightness values of a previous image.

According to embodiments, a first marker, particularly one or more first marker, may be provided on the shaft component of the elevator system. The first marker may be positioned such that the first marker is imaged by the imaging sensor, when the elevator car moves along the travel axis of the elevator car. In some embodiments, the first marker may be provided on shaft equipment of the elevator system. The shaft equipment may be provided in the elevator shaft of the elevator system. For example, the one or more first marker may be provided on a guide rail of the elevator system, on a landing door of the elevator system and/or on a door frame for a landing door of the elevator system.

In embodiments, a controller communicatively coupled with the imaging sensor is configured for detecting the one or more first marker based on the shutter value of the imaging sensor, particularly while the elevator car is moving along the travel axis. In particular, the imaging sensor may be configured to provide the shutter value to the controller via the communicative coupling between the controller and the imaging sensor. The controller may be positioned on the elevator car or may be arranged remotely from the elevator car, e.g. in a machine room of the elevator system. The controller may be provided for example as a dedicated controller or may be integrated with an elevator controller for controlling the elevator system. In embodiments, the controller includes a processor and a memory. The memory may include a program, which, when executed by the processor, causes the controller to perform operations according to embodiments described herein. In particular, the controller may perform one or more operations according to methods described herein. More specifically, the controller may be configured to detect one or more markers according to embodiments, particularly one or more first marker, based on the shutter value of the imaging sensor. The controller may be configured to determine a position of the elevator car, e.g. a first position or current position.

In some embodiments, a first marker is detected once the first marker has entered the field of view of the imaging sensor and the imaging sensor has automatically adjusted the shutter value. The one or more first marker may be configured to interact with the imaging sensor such that imaging a first marker of the one or more first marker causes the imaging sensor to automatically adjust the shutter value, e.g. to a shutter value traversing a shutter value threshold.

According to embodiments, the first marker includes at least one first region to be imaged by the imaging sensor, the at least one first region having a first reflectance. The shaft component of the elevator system can include an unmarked region adjacent to the first marker in a direction of the travel axis, the unmarked region having a further reflectance different from the first reflectance. In particular, the unmarked region may be arranged on the same side of a shaft component as the first marker, more specifically on the same side facing the imaging sensor such that the unmarked region and the at least one first region can be imaged by the imaging sensor. In embodiments, the imaging sensor images the at least one first region and the unmarked region with different shutter values. Herein, values of reflectance may particularly refer to an average reflectance, e.g. an average reflectance over an area of the shaft component corresponding to a field of view of the imaging sensor.

In some embodiments, the first marker is detected based on a comparison of the shutter value to a shutter value threshold, particularly to a predetermined shutter value threshold. According to some embodiments, the first reflectance of the at least one first region of the first marker is lower than the further reflectance of the unmarked region. In particular, the at least one first region of the first marker may provide higher absorption or higher diffuse reflection than the unmarked region. The first marker or the at least one first region may be detected based on the shutter value exceeding a shutter value threshold. The shutter value threshold may be selected as a value between the shutter values corresponding to the first region and the unmarked region. Using a first reflectance lower than the further reflectance may reduce an impact of changes in the first reflectance over time due to wear or contamination of the first marker. In further embodiments, the first reflectance may be higher than the further reflectance of the unmarked region. For example, the at least one first region may have a specular reflective surface. In such embodiments, the first marker or the at least one first region may be detected based on the shutter value falling below a shutter value threshold.

According to some embodiments, the one or more first marker is fabricated on a shaft component by laser writing, particularly on shaft equipment of the elevator system. In particular, the one or more first marker may be fabricated by laser writing on a shaft component made from metal and/or plastic, or on a part of a shaft component made from metal and/or plastic. For example, the one or more first marker may be fabricated by laser writing on a metal surface of the shaft component or on a plastic surface of the shaft component. The one or more first marker may be fabricated by laser writing for example on the guide rail, on one or more landing doors and/or on one or more door frames. Fabricating the one or more first marker by laser writing may particularly provide efficient fabrication of the one or more first markers and/or avoid additional steps for mounting the markers.

According to embodiments, a first position of the elevator car is determined based on the detection of the first marker. In particular, the first position may be the current position of the elevator car. The first position may be the absolute position of the elevator car or a relative position, particularly relative to a landing door. The first position can be determined by a controller communicatively coupled with the imaging sensor. The first position can be determined based on marker position data associated with the first marker.

According to some embodiments, an approximate position of the elevator car is tracked based on images acquired by the imaging sensor, particularly based on images of the shaft component of the elevator system. Tracking can be performed by a controller according to embodiments described herein. Tracking the approximate position can include determining a distance traveled by the elevator car between the acquisition of two subsequent images of the acquired images, particularly between two subsequent images having an overlap with each other. For example, the approximate position may be determined using image evaluation as described herein, such as image correlation algorithms. In particular, the imaging sensor used for tracking the approximate position can be an optical tracking sensor according to embodiments of the present disclosure, e.g. an optical flow sensor. The approximate position may be determined based on a previous position and further based on the distance traveled between the two subsequent images. However, the approximate position determined via tracking may be inaccurate. In particular, over time, tracking the approximate position using the imaging sensor may accumulate a position error, for example a position error proportional to the traveled distance. To provide accurate positioning of the elevator car within the elevator shaft, embodiments of the present disclosure provide systems and methods for determining or calibrating the position of the elevator car. In particular, the first position of the elevator car may be determined based on the approximate position and based on the detection of the first marker. The first position may be determined further based on marker position data associated with the first marker.

For example, a plurality of first markers can be provided in the elevator system. The plurality of first markers may herein be referred to as a plurality of position calibration markers. The plurality of first markers may be arranged along the travel axis of the elevator car, the plurality of first markers being configured to be imaged by the imaging sensor while the elevator car moves along the travel axis. In embodiments, the marker position data may include the positions of the plurality of first markers, particularly the absolute positions of the plurality of first markers, and/or the distances between the plurality of first markers. In some embodiments, the plurality of first markers may be positioned at regular distances along the travel axis. For example, the regular distance may be at least 30 cm, particularly at least 50 cm or at least 70 cm, and/or maximum 2.5 m, particularly maximum 2 m or maximum 1.5 m. In some embodiments, the plurality of first markers may be essentially identical first markers. For example, each of the plurality of first markers may have exactly one first region according to embodiments described herein.

In embodiments, a controller of a system according to embodiments may track an approximate position of the elevator car, particularly an approximate absolute position. Tracking the approximate position may have a position error of e.g. approximately 1%. Upon detection of a first marker of the plurality of first markers based on a change in the shutter value, the controller may determine the current position of the elevator car to be a first position associated with the first marker. For example, the controller may calibrate the approximate position to the closest of the positions of the first markers, the positions of the first markers being included in the marker position data or being calculated from the marker position data. For example, if the plurality of first markers are positioned at regular distances, the absolute positions of the first markers may be multiples of the regular distance between the first markers plus an offset of a first marker with respect to a reference point of an absolute position coordinate system of the elevator system. Calibrating an approximate position by determining a more accurate first position particularly avoids the accumulation of a large position error. After determining the first position of the elevator car, the approximate position may be further tracked by consecutively adding the distances traveled between further images acquired by the imaging sensor to the first position.

According to some embodiments, the first marker includes at least one second region to be imaged by the imaging sensor, the at least one second region being arranged adjacent to the at least one first region in a direction of the travel axis, wherein the at least one second region has a second reflectance different from the first reflectance. In particular, detecting the first marker may include imaging each of the at least one first region and each of the at least one second region. In some embodiments, the second reflectance of the at least one second region may be the same as a further reflectance of an unmarked region adjacent to first marker along the travel axis. In further embodiments, the second reflectance may be different from the first reflectance and different from the further reflectance. In embodiments, each of the at least one first region and/or the at least one second region may have a region length along the travel axis of at least 5 mm, particularly at least 7 mm or at least 10 mm, and/or maximum 30 mm, particularly maximum 20 mm or maximum 15 mm. In some embodiments, the total number of regions of the first marker, the regions particularly including the at least one first region and the at least one second region, may be maximum 15, particularly maximum 12 or maximum 10.

In some embodiments, the first marker includes a sequence of regions including the at least one first region and the at least one second region. When passing the sequence of regions, the imaging sensor may automatically adjust the shutter value in response to the sequence of regions. A series of shutter values associated with a series of images acquired by the imaging sensor may be determined and at least temporarily stored, e.g. by the controller communicatively coupled to the imaging sensor. The controller may identify a first sequence of shutter values in the series of shutter values, the first sequence corresponding to the sequence of the at least one first region and of the at least one second region of the first marker in a direction of the travel axis. The first sequence may include one or more first shutter values indicative of the first reflectance of the at least one first region and one or more second shutter values indicative of the second reflectance of the at least one second region. The sequence of regions, and particularly the length of regions along the travel axis, and the corresponding sequence of shutter values may encode a marker identifier corresponding to the first marker. For example, the marker identifier may be a binary number, wherein each digit of the binary number corresponds to the shutter value traversing or not traversing a shutter value threshold in a region of the first marker.

In embodiments, the first marker is detected based on the identified first sequence. For example, the first marker may be detected by matching, e.g. by the controller, the identified first sequence to the first marker based on marker identifier data. The marker identifier data may link one or more sequences of shutter values including the first sequence to one or more markers including the first marker. In particular, the marker identifier data may include a marker identifier encoded in the first sequence to link the identified first sequence to the first marker. The marker identifier data may be stored, e.g., in the controller. Based on the detection of the first marker and further based on marker position data indicative of a position of the first marker, the first position of the elevator car may be determined, particularly a first position of the elevator car corresponding to or relative to the position of the first marker.

According to embodiments, a second marker different from the first marker may be positioned or mounted on the shaft component. The second marker may include any of the features described herein with respect to the first marker. In particular, the second marker may be positioned such that the second marker is imaged by the imaging sensor while the elevator car is moving. In embodiments, the second marker is positioned at a different position along the travel axis than the first marker. The second marker may include a further sequence of at least one first region and at least one second region, the further sequence particularly being different from the sequence of regions of the first marker. According to embodiments, the second marker may be detected based on the shutter value while moving the elevator car. For example, the second marker may be detected based on a second sequence of shutter values associated with the further sequence of regions of the second marker. The second sequence may be identified, e.g. by the controller, in a series of shutter values used for imaging by the imaging sensor. The identified second sequence may be matched to the second marker based on the marker identifier data. Based on the detection of the second marker, a second position of the elevator car can be determined analogously to the determination of the first position based on the detection of the first marker.

In some embodiments, a plurality of markers including the first marker, the second marker and/or one or more further markers are provided. The one or more further markers may include any of the features described herein with respect to the first marker or the second marker. Each of the plurality of markers may include a unique sequence of at least one first region and at least one second region. The plurality of markers may herein be referred to as plurality of unique markers. In embodiments, each of the plurality of markers is associated with individual marker position data. For example, each of the plurality of markers may be positioned at a landing of the elevator system, e.g. on a landing door or on a door frame. The individual marker position data may include data for each of the plurality of markers, the data associating the plurality of markers with the corresponding landings of the elevator system. In particular, the individual marker position data may include a landing number or floor number of the elevator system for each of the plurality of markers.

While moving the elevator car, the controller may detect and identify a marker of the plurality of markers based on a unique sequence of shutter values associated with the marker. Based on the identified marker and based on the individual marker position data associated with the identified marker, the controller may determine that the elevator car is currently positioned at a landing corresponding to the identified marker. Alternatively or additionally, the individual marker position data may include a position, particularly an absolute position corresponding to the marker. For example, the absolute position may correspond to a reference point or calibration point for the positioning system, such as a maximum position or minimum position of the elevator car along the travel axis. In embodiments, each of the plurality of markers has a marker length along the travel axis of at least 5 mm, particularly at least 7 mm or at least 10 mm and/or of maximum 200 mm, particularly maximum 150 mm or maximum 100 mm.

According to some embodiments of the present disclosure, a system for determining a position of the elevator car includes a first system for determining an absolute position of the elevator car, and a second system for determining a relative position of the elevator car, particularly a relative position with respect to one or more landings of the elevator system. In particular, the first system can include a plurality of position calibration markers according to embodiments described herein. The first system includes a first imaging sensor positioned on the elevator car for imaging the plurality of position calibration markers. The plurality of position calibration markers may be positioned on the shaft component for calibrating an approximate position determined via an imaging sensor as described herein. In particular, the plurality of position calibration markers may be positioned at regular distances along the travel axis of the elevator car. The plurality of position calibration markers may be particularly provided on a guide rail of the elevator system.

The second system may include a plurality of unique markers. In particular, each of the plurality of unique markers may have a unique sequence of at least one first region and at least one second region. For example, each of the plurality of unique markers may be positioned at a landing of the elevator system according to embodiments described herein, particularly on a landing door or on a door frame for a landing door. The second system can include a second imaging sensor positioned on the elevator car for imaging the plurality of unique markers. Embodiments including a first system and a second system may particularly provide an independent determination of an absolute position of the elevator car and of a relative position of the elevator car, e.g. relative to a landing of the elevator system.

Embodiments of the present disclosure provide methods and systems for determining a position of an elevator car based on imaging of a shaft component of an elevator system. Embodiments advantageously use the shutter value of the imaging system for reliable marker detection to determine the position of the elevator car. For example, marker detection based on the shutter value may avoid the use of marker recognition within an acquired image. Instead, the marker can be detected reliably for instance via thresholding. Embodiments provide calibration of approximate relative positions determined by optical tracking to determine accurate absolute or relative positions of the elevator car. Accurate and reliable determination of the position can increase the safety of elevator operation. Further, the use of imaging systems and markers according to embodiments may require less additional sensor equipment and/or may require less computing effort, thus reducing e.g. a complexity or costs of a position determination system.

Reference will now be made in detail to various embodiments, one or more examples of which are illustrated in the figures. Within the following description of the drawings, the same reference numbers refer to same components. Generally, only the differences with respect to individual embodiments are described. Each example is provided by way of explanation and is not meant as a limitation. Further, features illustrated or described as part of one embodiment can be used on or in conjunction with other embodiments to yield yet a further embodiment. It is intended that the description includes such modifications and variations.

### DESCRIPTION OF THE DRAWINGS

FIG. 1 shows a schematic view of an elevator system according to the present disclosure;

FIG. 2 illustrates a system for determining a position of the elevator car according to an embodiment;

FIG. 3 schematically illustrates an imaging sensor moving along a shaft component for detecting a first marker;

FIG. 4 shows a graph of a shutter value over distance traveled by the imaging sensor according to FIG. 3;

FIG. 5 shows a flow diagram of a method according to an embodiment;

FIG. 6 schematically illustrates an imaging sensor moving along a shaft component for detecting a first marker according to a further embodiment;

FIG. 7 shows a graph of a shutter value over distance traveled by the imaging sensor according to FIG. 6;

FIG. 8 shows a schematic view of an elevator system according to a further embodiment;

FIG. 9 shows a flow diagram of a method according to the present disclosure; and

FIG. 10 illustrates a schematic view of an elevator system according to yet a further embodiment.

### DETAILED DESCRIPTION

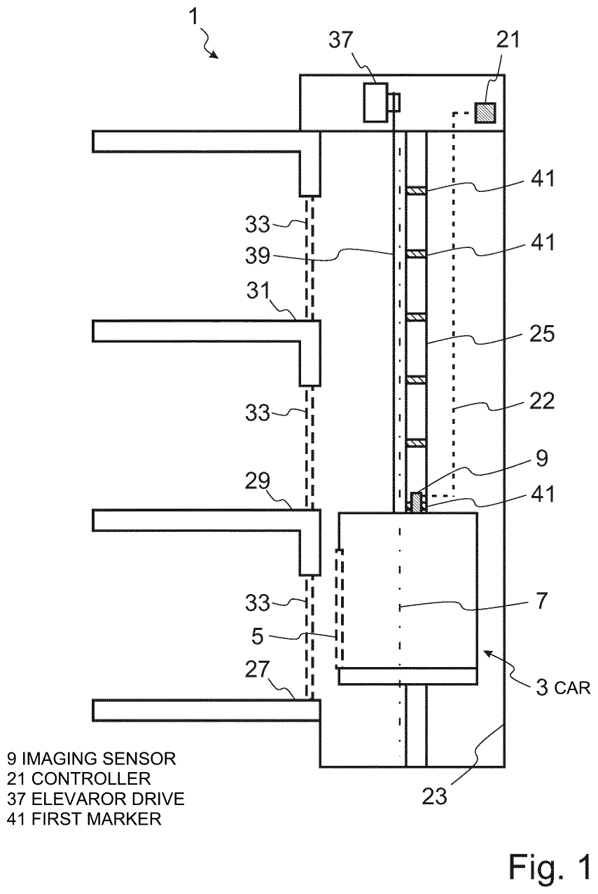

FIG. 1 illustrates a schematic view of an elevator system 1. The elevator system 1 includes an elevator car 3 which is movable along a travel axis 7, particularly along a vertical axis. The elevator system 1 includes an elevator shaft 23 and a plurality of landings, particularly a first landing 27, a second landing 29 and a third landing 31. In further embodiments, an elevator system may include any number of landings. In FIG. 1, each of the landings includes a landing door 33 which is arranged in a corresponding door frame (not shown). Passengers may enter and exit the elevator car 3 at a landing through a landing door 33 and through a car door 5 of the elevator car 3. The elevator system 1 further includes a machine room with an elevator drive 37 for driving the elevator car 3. The elevator drive 37 and the elevator car 3 are connected via a cable 39. The elevator car 3 is guided within the elevator shaft 23 by a guide rail 25, the guide rail 25 being fixed to a lateral wall of the elevator shaft 23 with respect to the elevator car 3. In particular, the elevator car 3 drives along the guide rail 25 in a direction of the travel axis 7.

The elevator system 1 of FIG. 1 includes a system for determining a position of the elevator car 3. The system includes an imaging sensor 9 mounted to the elevator car 3. The imaging sensor 9 is communicatively coupled to a controller 21 of the system via a communicative connection 22. The system further includes a plurality of first markers 41 provided on a shaft component of the elevator system 1, in FIG. 1 particularly on the guide rail 25. The plurality of first markers 41, herein also referred to as plurality of position calibration markers, are arranged at regular distances along the travel axis 7. In FIG. 1, the plurality of first markers 41 are particularly fabricated by laser writing on the guide rail 25.

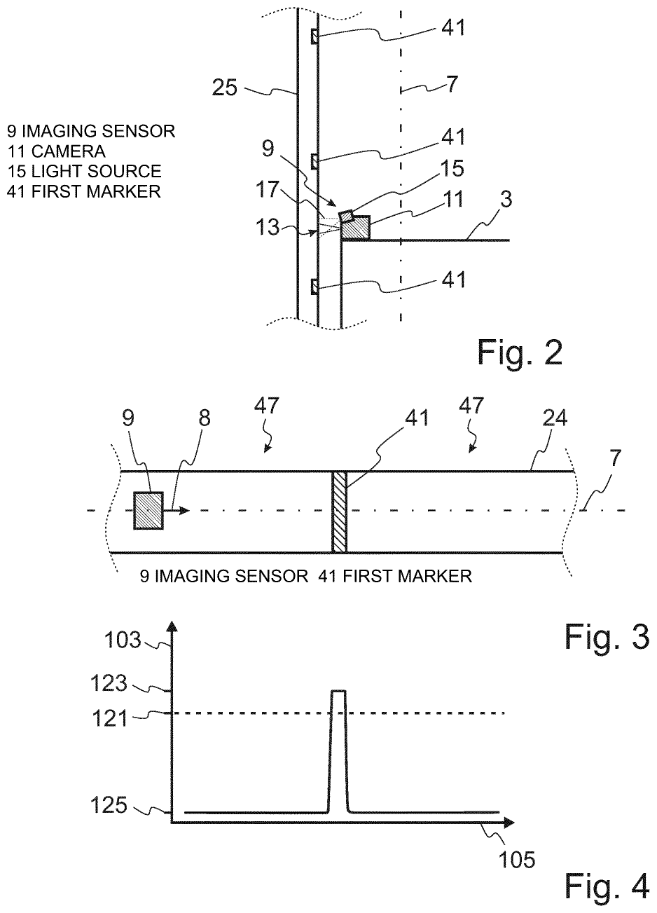

As illustrated in more detail in FIG. 2, the imaging sensor 9 is arranged on the elevator car 3 such that the imaging sensor 9 can image the guide rail 25 while the elevator car 3 is moving along the travel axis 7. The imaging sensor 9 particularly includes a camera 11 for acquiring images of a field of view 13 of the camera 11 on the guide rail 25. The imaging sensor 9 further includes a light source 15 providing an illumination 17 for the field of view 13.

FIGS. 3 and 4 schematically illustrate the detection of a first marker 41 of a plurality of first markers 41 on a shaft component, particularly on shaft equipment 24 such as the guide rail 25 of FIGS. 1 and 2. FIG. 3 illustrates a part of the shaft equipment 24 and an imaging sensor 9 mounted on an elevator car moving in a travel direction 8 along the travel axis 7, wherein the elevator car is not shown for clarity. The shaft equipment 24 includes a first marker 41 having exactly one first region with a first reflectance. The first reflectance is different from a further reflectance of unmarked regions 47 adjacent to the first marker 41 in directions along the travel axis 7. More specifically, the first reflectance of the first region is lower than the further reflectance of the unmarked regions 47.

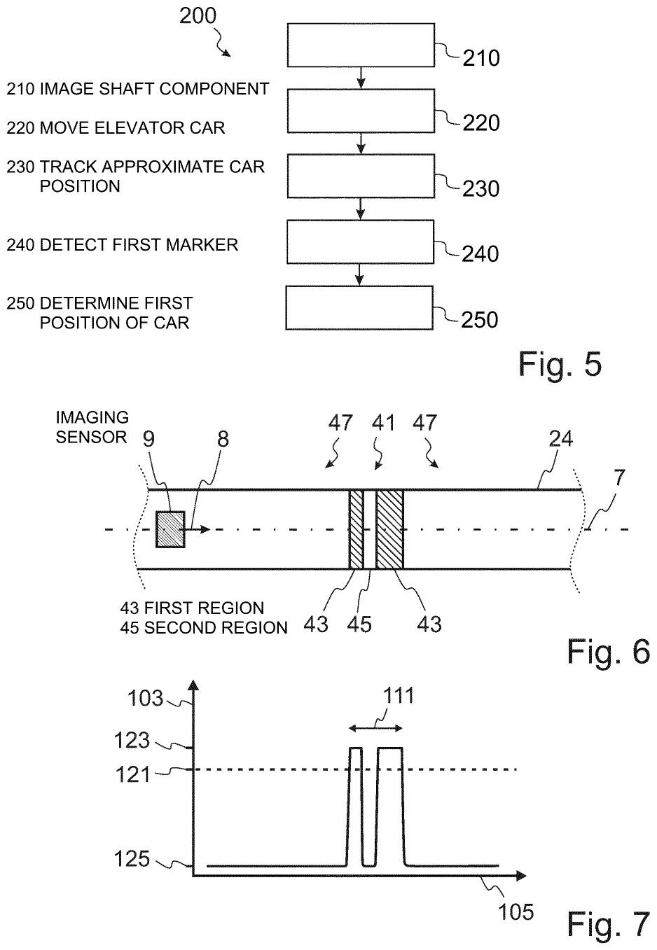

FIG. 5 illustrates a flow diagram of a method 200 of determining a position of the elevator car 3, particularly based on a first marker 41 as illustrated in FIG. 3. The method 200 is illustrated as a plurality of blocks representing method steps. At block 210, the imaging sensor 9 images the shaft component of the elevator system 1, particularly shaft equipment 24. While imaging, the imaging sensor 9 automatically adjusts a shutter value of the imaging sensor 9. At block 220, the elevator car 3 moves in a travel direction 8 along the travel axis 7. At block 230, the method 200 includes tracking an approximate position of the elevator car 3 based on images acquired by the imaging sensor 9 according to embodiments described herein.

At block 240, the method 200 includes detecting the first marker 41 based on the shutter value while moving the elevator car 3. For example, FIG. 4 illustrates a graph of the shutter value 103 versus position 105, as the elevator car 3 and the imaging sensor 9 move in the travel direction 8 (FIG. 3). The imaging sensor 9 automatically adjusts the shutter value 103 to image the unmarked region 47 with a low shutter value 125 indicative of the further reflectance of the unmarked region 47. When the imaging sensor 9 reaches the first region of the first marker 41, the imaging sensor 9 automatically increases the shutter value 103 to a first shutter value 123 to image the first region. In particular, the imaging sensor 9 increases the exposure time to image the first region, which has a lower reflectance and appears less bright than the unmarked regions 47. As shown in FIG. 4, the first shutter value 123 is larger than a predetermined shutter value threshold 121. By continuous comparison of the shutter value 103 with the shutter value threshold 121, the controller 21 detects the presence of the first marker 41 when the shutter value 103 exceeds the shutter value threshold 121.

At block 250 in FIG. 5, a first position of the elevator car 3 is determined based on the detection of the first marker 41. In particular, the tracked approximate position is calibrated based on detection of the first marker. The controller 21 determines the first position based on the detection of the first marker 41 and further based on marker position data which includes information on absolute marker positions of the plurality of first markers 41. The approximate position of the elevator car 3 is particularly calibrated to the marker position of the first marker 41 which is closest to the approximate position. Based on the calibration, the first position of the elevator car 3 can be determined precisely based on the first marker 41. For example, arranging first markers 41 at regular distances along the travel axis allows for regularly calibrating the approximate position such that a position error of the approximate position does not accumulate over time to a critical position error.

As illustrated in FIG. 4 the shutter value 103 increases to a first shutter value 123 above the shutter value threshold 121, when the imaging sensor 9 reaches the first marker 41, and drops back to the low shutter value 125, when the imaging sensor 9 has passed the first region of the first marker 41. Detecting the first marker 41 based on the shutter value 103 may provide a particularly robust detection of the first marker, which for example does not rely on the recognition of a pattern within an image.

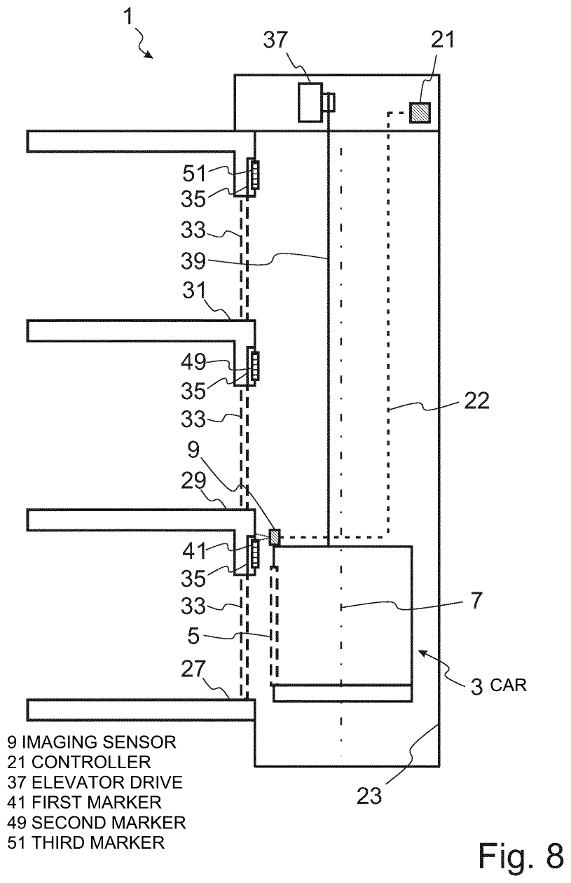

FIGS. 6 and 7 illustrate the detection of a first marker 41 according to a further embodiment of the present disclosure. The first marker 41 of FIG. 6 includes more than one first region 43 and a second region 45. The first regions 43 have a first reflectance which is lower than the further reflectance of the unmarked region 47. In the example of FIG. 6, a second reflectance of the second region 45 is essentially the same as the further reflectance of the unmarked regions 47. The first marker 41 is provided on shaft equipment 24. In particular, as shown in FIG. 8, the shaft equipment 24 may be a landing door 33 or a door frame 35.

For example, FIG. 8 illustrates an elevator system 1 with an elevator car 3 and various landings similar to FIG. 1. In FIG. 8, a plurality of markers, particularly a plurality of unique markers, are arranged on the door frames 35 of the respective landings. The unique markers include a first marker 41 as illustrated e.g. in FIG. 6, a second marker 49 and a third marker 51. The second marker 49 and the third marker 51 are configured similarly to the first marker 41, but with different sequences of one or more first regions 43 and one or more second regions 45. In further embodiments, the plurality of unique markers may include any number of markers such as two or more markers. It should further be understood that while FIG. 8 shows the unique markers arranged on a top side of the door frames 35, in further embodiments the unique markers may be arranged on the door frames 35 at a side of the landing doors 33, or on the landing doors 33. The imaging sensor 9 is arranged such that it can image the unique markers when the elevator car 3 moves along the travel axis 7.

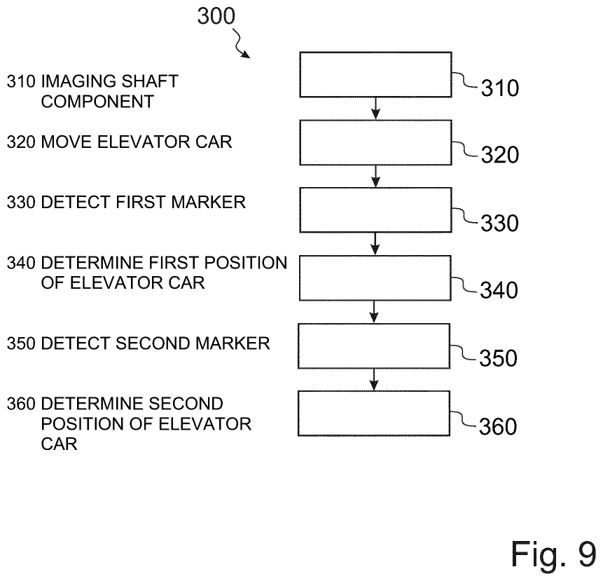

FIG. 9 illustrates a further embodiment of a method 300 of steps illustrated in blocks for determining a position of the elevator car 3, particularly based on a plurality of unique markers as illustrated in FIGS. 6 and 8. At block 310, the method 300 includes imaging the shaft component using the imaging sensor 9. Referring to FIGS. 6 and 7, the imaging sensor 9 may image the unmarked region 47 with a low shutter value 125. At block 320, the elevator car 3 moves in a travel direction 8 along the travel axis 7.

At block 330, the method 300 includes detecting the first marker 41. The first marker 41 is particularly detected based on the shutter value 103, which is automatically adjusted along the travel direction 8 by the imaging sensor 9. The controller 21 may at least temporarily store a series of shutter values used by the imaging sensor 9 for imaging the shaft component. At block 330, detecting the first marker 41 includes identifying a first sequence 111 (FIG. 7) of shutter values in the series of shutter values 103, the first sequence 111 corresponding to the sequence of one or more first regions 43 and one or more second regions 45 of the first marker 41.

For example, referring to FIGS. 6 and 7, the first marker 41 is detected based on a first sequence 111 of shutter values 103, wherein the first sequence 111 includes a first set of shutter values exceeding a shutter value threshold 121 over a first length along the travel axis 7. The first set of shutter values corresponds to the first region 43 first reached by the imaging sensor 9 along the travel direction 8. For the first marker 41 shown in FIG. 6, the first length particularly corresponds to a predetermined region length. The first sequence 111 of shutter values further includes a second set of shutter values corresponding to the second region 45, the second set of shutter values being lower than the shutter value threshold 121 over a second length along the travel direction 8. For the first marker 41 in FIG. 6, the second length essentially corresponds to the predetermined region length. The first sequence 111 further includes a third set of shutter values corresponding to the first region 43 imaged after the second region 45 in FIG. 6. The third set of shutter values exceeds the shutter value threshold 121 over a third length along the travel direction 8. In the example of FIG. 6, the third length is twice the predetermined region length. Based on the first sequence 111 of the regions and particularly based on the lengths of the respective regions, the first marker 41 is identified. Specifically, the sequence of one or more first regions 43 and one or more second regions 45, and their respective lengths can encode a marker identifier for the first marker 41. For example, in FIG. 6, the first sequence of shutter values encodes the binary number 1011. Based on a comparison of the marker identifier to marker identifier data stored in the controller, the first marker 41 is identified. While the first marker 41 in FIG. 6 is illustrated with a length of four predetermined region lengths, it should be understood that in further embodiments, markers may include a different number, particularly a higher number, of regions or of predetermined regions lengths.

At block 340, a first position of the elevator car 3 is determined based on the detected first marker 41. In the method 300, the first position is a position relative to a landing. In particular, the controller 21 matches the first marker 41 to a landing number stored in marker position data of the controller 21. For example, referring to FIG. 8, the controller 21 can detect the first marker 41 and determine the first position of the elevator car 3 to be at the first landing 27 of the elevator system 1.

At block 350, the method 300 includes detecting a second marker 49 different from the first marker 41 while moving the elevator car 3. In particular, the second marker 49 is detected based on a second sequence of shutter values. The second sequence is indicative of a sequence of one or more first region and one or more second region, the sequence of the second marker 49 being different from the sequence of the first marker 41. The second marker 49 is detected analogously to the first marker 41.

At block 360, the method 300 further includes determining a second position of the elevator car 3, the second position corresponding to a position of the second marker 49 in the elevator system 1. For example, upon detection of the second marker 49 in an elevator system 1 as in FIG. 8, the controller 21 determines the second position of the elevator car 3 to be at the second landing 29 of the elevator system 1. The method 300 may further include the detection of further markers while moving the elevator car 3, and determination of corresponding further positions of the elevator car 3. For example, the controller 21 of FIG. 8 may be configured to detect the third marker 51 and to determine a third position of the elevator car 3 based on the detection of the third marker 51, the third position corresponding to the third landing 31.

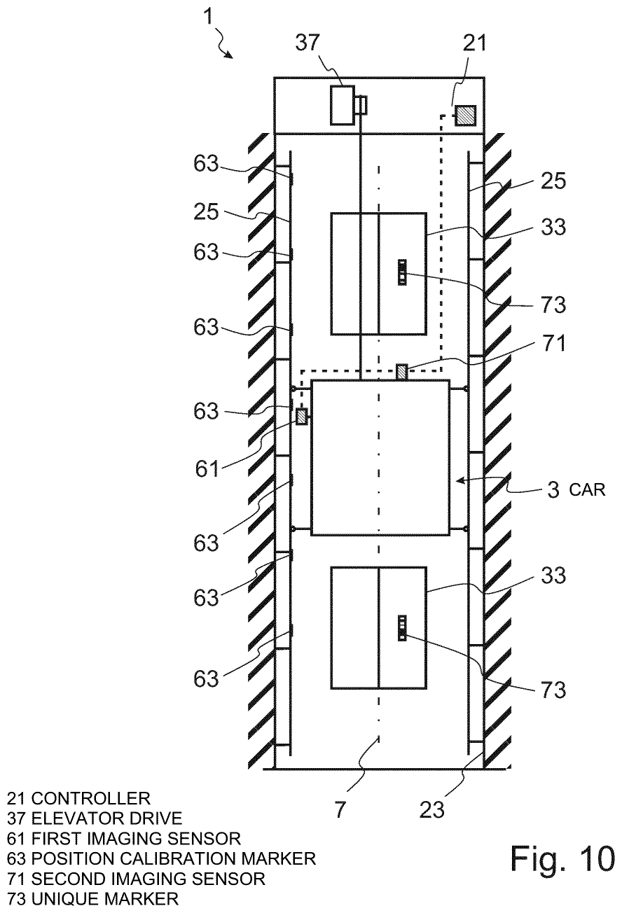

FIG. 10 schematically shows a further embodiment of an elevator system 1 including a system for determining a position of the elevator car 3. The system particularly includes a first system for determining an absolute position of the elevator car 3. The first system includes a first imaging sensor 61 and a plurality of position calibration markers 63 according to embodiments described herein. In FIG. 10, the plurality of position calibration markers 63 are provided at regular distances along the travel axis 7 on one of the guide rails 25. The first imaging sensor 61 and the controller 21 are configured to perform operations for determining the absolute position of the elevator car 3, for example according to method 200 (FIG. 5). Specifically, an approximate absolute position is tracked using the first imaging sensor 61, which images the guide rail 25. Based on the detection of a marker of the plurality of position calibration markers 63, the approximate position is calibrated to an accurate absolute position. In particular, the current position of the elevator is determined accurately based on the detection of the marker and based on marker position data associated with the plurality of position calibration markers 63.

The system further includes a second system for determining a relative position of the elevator car 3, specifically for determining a relative position with respect to landings of the elevator system 1. The second system includes a second imaging sensor 71 and a plurality of unique markers 73 according to embodiments described herein. In FIG. 10, each of the plurality of unique markers 73 is positioned on a landing door 33 of the elevator system 1. The second imaging sensor 71 is mounted to the elevator car 3 such that the second imaging sensor 71 can image the plurality of unique markers 73 while the elevator car 3 is moving. The second imaging sensor 71 and the controller 21 communicatively coupled to the second imaging sensor 71 are configured to perform operations for determining the relative position of the elevator car 3, such as the operations according to method 300 (FIG. 9). In particular, a marker of the plurality of unique markers 73 is detected based on a sequence of shutter values associated with the marker. Upon detection of the marker 73, the controller 21 determines a relative position of the elevator car 3. In particular, the controller 21 determines that the elevator car 3 is positioned at the landing door 33 having the marker positioned thereon. The elevator system 1 of FIG. 10 can advantageously provide an independent, robust and accurate determination of an absolute position of the elevator car 3 and of a position relative to a landing, particularly relative to a landing door 33.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method of determining a position of an elevator car of an elevator system, the elevator car being movable in an elevator shaft of the elevator system, the method comprising steps of:
imaging a shaft component of the elevator system using an imaging sensor mounted to the elevator car, the imaging sensor automatically adjusting a shutter value of the imaging sensor during the imaging based on a reflectance value in a field of view of the imaging sensor;
moving the elevator car along a travel axis of the elevator car in the elevator shaft;
detecting a first marker with the imaging sensor while moving the elevator car, the first marker being positioned on the shaft component of the elevator system, wherein the first marker is detected based on the shutter value of the imaging sensor when the first marker is in the field of view; and
determining a first position of the elevator car based on the detection of the first marker.

17. The method according to claim 16 wherein the first marker includes a first region having a first reflectance, wherein the shaft component of the elevator system includes an unmarked region adjacent to the first marker in a direction of the travel axis, the unmarked region having a further reflectance different from the first reflectance, and wherein imaging the shaft component includes imaging the first region and the unmarked region with different ones of the shutter values.

18. The method according to claim 16 including detecting the first marker based on a comparison of the shutter value of the imaging sensor when the first marker is in the field of view to a shutter value threshold.

19. The method according to claim 16 wherein the shaft component of the elevator system is a shaft equipment arranged in the elevator shaft, and wherein the first marker is provided on the shaft equipment.

20. The method according to claim 16 including steps of:
tracking an approximate position of the elevator car based on images acquired by the imaging sensor by determining a distance traveled by the elevator car between acquisitions of two subsequent ones of the acquired images; and
determining the first position of the elevator car based on the approximate position and based on the detection of the first marker.

21. The method according to claim 16 wherein the elevator system includes a plurality of the first markers, the plurality of first markers being arranged along the travel axis of the elevator car, and wherein the first markers are adapted to be imaged by the imaging sensor while moving the elevator car along the travel axis.

22. The method according to claim 21 wherein the first markers are arranged at regular distances along the travel axis.

23. The method according to claim 16 wherein the first marker includes a first region having a first reflectance, wherein the shaft component of the elevator system includes an unmarked region adjacent to the first marker in a direction of the travel axis, the unmarked region having a further reflectance different from the first reflectance, wherein the first marker includes a second region adjacent to the first region in the direction of the travel axis, wherein the second region has a second reflectance different from the first reflectance, and wherein imaging the shaft component includes imaging the first region, the second region and the unmarked region with different ones of the shutter values,

24. The method according to claim 23 wherein detecting the first marker comprises:
determining a series of the shutter values associated with a series of images of the shaft component acquired by the imaging sensor; and
identifying a first sequence of the shutter values in the series of the shutter values, the first sequence corresponding to a sequence of at least one of the first region and at least one of the at least one second region of the first marker in the direction of the travel axis.

25. The method according to claim 16 further comprising steps of:
detecting a second marker different from the first marker during the moving of the elevator car, the second marker being positioned on the shaft component of the elevator system, wherein the second marker is detected based on the shutter value of the imaging sensor; and
determining a second position of the elevator car based on the detection of the second marker.

26. A system for determining a position of an elevator car of an elevator system, the elevator car being movable in an elevator shaft of the elevator system, the system for determining comprising:
an imaging sensor mounted to the elevator car, the imaging sensor automatically adjusting a shutter value of the imaging sensor during imaging of a shaft component of the elevator system;
a first marker on the shaft component;
a controller communicatively coupled to the imaging sensor; and
wherein the controller detects the first marker on the shaft component based on the shutter value of the imaging sensor, and wherein the controller determines a first position of the elevator car in the elevator shaft based on the detection of the first marker.

27. The system for determining according to claim 26 wherein the shaft component is a shaft equipment, and wherein the first marker is provided on the shaft equipment.

28. The system for determining according to claim 27 wherein the shaft equipment is a guide rail of the elevator system, a landing door of the elevator system or a door frame of the elevator system.

29. The system for determining according to claim 27 wherein the first marker is fabricated on the shaft equipment as a laser writing.

30. An elevator system comprising:
an elevator car movable in an elevator shaft;
a shaft component of the elevator system; and
the system for determining according to claim 26 wherein the imaging sensor is mounted to the elevator car, and wherein the first marker is positioned on the shaft component of the elevator system.
